(19) United States
(12) Patent Application Publication
(10) Pub. No.: US 2022/0335497 A1
(43) Pub. Date: Oct. 20, 2022

(54) MERCHANDISE REGISTRATION APPARATUS AND METHOD

(71) Applicant: Toshiba Tec Kabushiki Kaisha, Tokyo (JP)

(72) Inventor: Kaisei TAKAHASHI, Mishima (JP)

(73) Assignee: Toshiba Tec Kabushiki Kaisha, Tokyo (JP)

(21) Appl. No.: 17/575,402

(22) Filed: Jan. 13, 2022

(30) Foreign Application Priority Data
Apr. 14, 2021 (JP) 2021-068387

(51) Int. Cl. G06Q 30/06

(52) U.S. Cl. CPC G06Q 30/0627; G06Q 20/18

(57) ABSTRACT

A merchandise registration apparatus includes a processor configured to receive as an input a merchandise identification information that identifies merchandise and related information relating to a state of the merchandise identified by the merchandise identification information; perform merchandise registration based on the merchandise identification information; receive instruction information indicating an instruction to execute a privilege process for providing a privilege to a customer; and execute the privilege process in response to determining, based on the related information, the merchandise identified by the merchandise identification information as defective merchandise, and receiving the instruction information.

### CROSS-REFERENCE TO RELATED APPLICATION

This application is based upon and claims the benefit of priority from Japanese Patent Application No. 2021-068387, filed on Apr. 14, 2021, the entire contents of which are incorporated herein by reference.

### FIELD

Embodiments described herein relate generally to a merchandise registration apparatus and a method.

### BACKGROUND

A self-service checkout system for collecting expired merchandise is known. In such a system, if merchandise of which a merchandise code is read by an operation of a customer is expired merchandise, a registration apparatus in the self-service checkout system performs a display indicating that the merchandise is the expired merchandise. The customer who sees the display indicating that the merchandise is the expired merchandise puts the expired merchandise into a collection box provided near the merchandise registration apparatus. Accordingly, a store that sells the merchandise can collect the expired merchandise.

In such a situation, a store can collect the expired merchandise, but the customer cannot purchase merchandise that he or she intends to purchase or should purchase the merchandise separately. Therefore, the customer does not benefit from this technique, and the customer may feel discomfort or dissatisfaction depending on a situation.

### DESCRIPTION OF THE DRAWINGS

FIG. 1 is a diagram illustrating an outline of a payment system including a merchandise registration apparatus according to an exemplary embodiment;

FIG. 2 is a diagram illustrating an appearance of a shopping cart on which the merchandise registration apparatus is mounted;

FIG. 3 is a block diagram illustrating a hardware configuration of the merchandise registration apparatus;

FIG. 4 is a diagram illustrating a data configuration of a merchandise information storage unit of the merchandise registration apparatus;

FIG. 5 is a diagram illustrating a data configuration of a defective merchandise storage unit of the merchandise registration apparatus;

FIG. 6 is a diagram illustrating a data configuration of a clerk master stored in a memory unit of the merchandise registration apparatus;

FIG. 7 is a diagram illustrating a content of data indicated by a barcode used in an exemplary embodiment;

FIG. 8 is a block diagram illustrating a functional configuration of a control unit in the merchandise registration apparatus;

FIG. 9 is a flowchart illustrating a process flow by the control unit;

FIG. 10 is a block diagram illustrating a hardware configuration of a merchandise registration apparatus according to an exemplary embodiment;

FIG. 11 is a diagram illustrating a data configuration of a merchandise information storage unit of the merchandise registration apparatus;

FIG. 12 is a diagram illustrating a data configuration of a merchandise master stored in a memory unit of the merchandise registration apparatus;

FIG. 13 is a block diagram illustrating a functional configuration of a control unit in the merchandise registration apparatus; and

FIG. 14 is a flowchart illustrating a process flow by the control unit.

### DETAILED DESCRIPTION

A problem to be solved is to provide a merchandise registration apparatus and a method capable of preventing discomfort or dissatisfaction felt by a customer who intends to purchase defective merchandise such as expired merchandise or the like.

In general, according to at least one embodiment, a merchandise registration apparatus includes a processor configured to receive as an input merchandise identification information that identifies merchandise and related information relating to a state of the merchandise identified by the merchandise identification information; perform merchandise registration based on the merchandise identification information; receive instruction information indicating an instruction to execute a privilege process for providing a privilege to a customer; and execute the privilege process in response to determining, based on the related information, the merchandise identified by the merchandise identification information as defective merchandise, and receiving the instruction information.

Hereinafter, a merchandise registration apparatus and a method of an exemplary embodiment will be described with reference to the drawings. The embodiment is not limited to the description hereinbelow. For example, the embodiment hereinbelow describes an example in which the merchandise registration apparatus is applied to a tablet terminal prepared by a store, and the merchandise registration apparatus may be applied to a portable terminal such as a smartphone or the like owned by a customer. The merchandise registration apparatus may be applied to a point of sales (POS) terminal operated by a clerk, a self-service POS terminal operated by the customer, or the like.

### First Embodiment

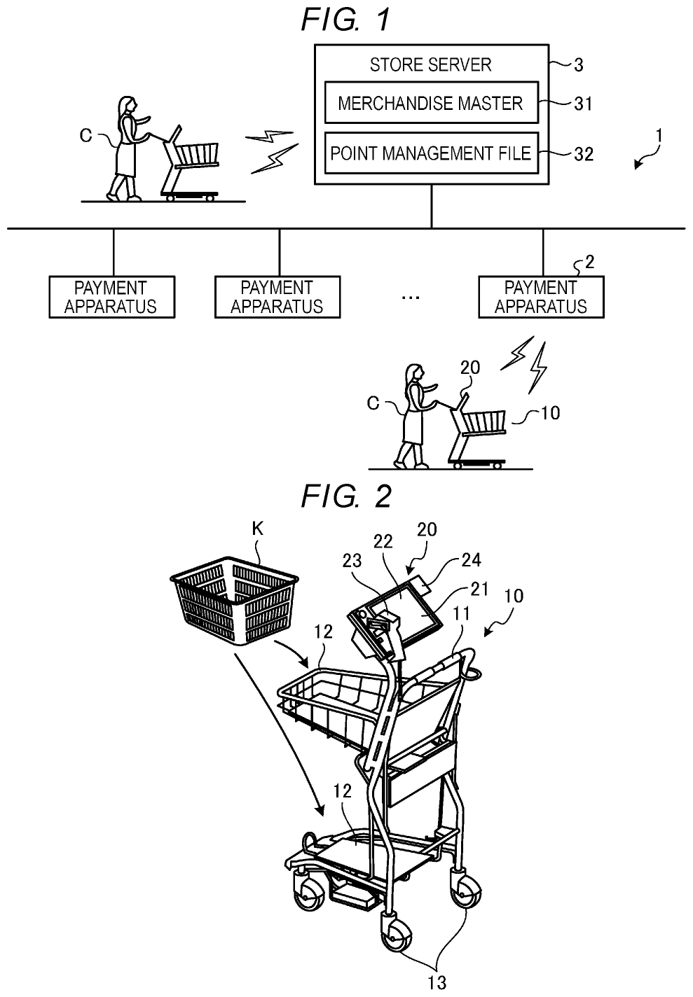

Hereinafter, a merchandise registration apparatus and a method according to at least one embodiment will be described with reference to the drawings. FIG. 1 is a diagram illustrating an outline of a payment system including a merchandise registration apparatus. A payment system 1 of the embodiment is applied to a store that sells merchandise, such as a supermarket or the like. The payment system 1 includes a plurality of payment apparatuses 2, a server 3, and a plurality of shopping carts 10. A tablet terminal 20 is mounted on each shopping cart 10. The payment apparatus 2 and the server 3 are connected to each other to be able to communicate with each other via a network such as a local area network (LAN) or the like. Each tablet terminal 20 is communicably connected to the payment apparatus 2 and the server 3 via a wireless LAN or the like.

For example, the payment apparatus 2 is a so-called self-service payment apparatus in which a customer C performs a payment operation by himself or herself. The payment apparatus 2 executes, based on payment information received from the tablet terminal 20, a payment process related to payment by cash settlement or cashless settlement such as credit card settlement or the like. The payment process is a process for paying a price of the merchandise purchased by the customer C. The payment apparatus 2 may be a POS terminal operated by a clerk.

The server 3 receives, from each payment apparatus 2, merchandise information and settlement information related to a settlement method or the like of the merchandise paid in the payment process. The server 3 receives, from each payment apparatus 2, sales information indicating a sales amount for a predetermined period (for example, one day). The server 3 is focused on managing the merchandise information, the settlement information, the sales information, or the like received from each payment apparatus 2, and performs sales management or the like at one store.

The server 3 stores a merchandise master 31 and a point management file 32. The merchandise master 31 is a master file in which a merchandise code and merchandise information (a merchandise name, a price, or the like) are associated with merchandise available in a store. Since the merchandise available in the store changes daily, the merchandise master is appropriately updated. The server 3 transmits the updated merchandise master 31 to the tablet terminal 20. The point management file 32 is a file that manages a point given to a member of the store. The point management file 32 is a file that stores a member ID that identifies the member (the customer) of the store in association with the point, and is appropriately updated based on the payment information or the like from each payment apparatus 2. The point management file 32 may be formed of a member information management file in which a member code, a full name, member information, and a point are associated with each other. Here, the point has a monetary value that can be used at the time of purchasing the merchandise, and is given to the customer C by the store. The server 3 functions as a point management apparatus that manages the point for each customer C.

The shopping cart 10 is installed in a sales floor of the store and is used for transporting the merchandise purchased by the customer C. The customer C stores the merchandise to be purchased in the shopping cart 10 while pushing the shopping cart 10 and moving the shopping cart 10 in the sales floor.

FIG. 2 is a diagram illustrating an appearance of the shopping cart 10 on which the tablet terminal 20 is mounted. The shopping cart 10 includes a handle 11, a basket placement unit 12, and a caster 13, and a tablet terminal 20 is mounted on the shopping cart 10. The handle 11 is provided for the customer C to grasp and move the shopping cart 10. The basket placement unit 12 is formed of an upper and lower two-stage structure, and can place a basket K for storing the merchandise purchased by the customer C in each of the two stages. The basket K may be provided to be integrated with the shopping cart 10. The casters 13 are respectively provided at lower four corners of the shopping cart 10. By rotating these casters 13 individually, the shopping cart 10 can move freely in the store. The shopping cart 10 is a moving body including the tablet terminal 20.

The tablet terminal 20 includes a display 21, a touch panel 22, a scanner 23, and a card reader 24. The tablet terminal 20 is operated by the customer C who moves in the store where the merchandise is sold, and is an example of the merchandise registration apparatus. The scanner 23 and the card reader 24 may be an external apparatus connected to the merchandise registration apparatus without forming the merchandise registration apparatus.

The display 21 is formed of, for example, a liquid crystal panel, and functions as a display unit for displaying various information. The display 21 displays, for example, merchandise information of merchandise registered as merchandise, an operator for operation by the customer C who is a user, or the like.

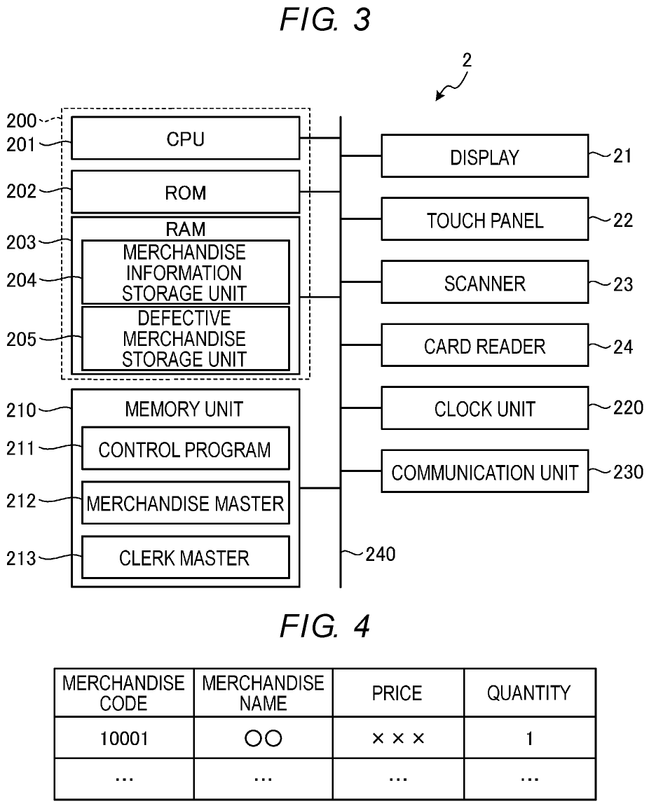

The touch panel 22 is provided on a surface of the display 21 and functions as an operation input unit used to input information corresponding to a touched location to a control unit 200 (refer to FIG. 3) of the tablet terminal 20. For example, the touch panel 22 inputs, to the control unit 200, a payment instruction indicating that payment information is to be transmitted to the payment apparatus 2. The payment information is information necessary for the payment process for paying the price of the merchandise purchased by the customer C.

The scanner 23 is detachably provided on the shopping cart 10. The scanner 23 reads a merchandise code and deadline information of merchandise from a code symbol attached to the merchandise. Specifically, the scanner 23 recognizes the code symbol such as a barcode and a two-dimensional code attached to the merchandise purchased by customer C optically or by capturing an image of the code symbol. Next, the scanner 23 decodes the recognized code symbol and reads the merchandise code and the deadline information indicated by the code symbol. In the embodiment, the code symbol attached to the merchandise is the barcode. The merchandise code is an example of merchandise identification information that identifies the merchandise. The deadline information is information indicating an expiration date of merchandise, and is an example of related information related to a state of the merchandise. A consumption expiration date, a sales expiration date in limited-time merchandise, or the like may be used as the deadline information, and the store can freely and selectively set which expiration date to use.

The scanner 23 reads a clerk code from a barcode printed on a clerk's name plate. The barcode recognized by the scanner 23 may be decoded by the control unit 200 of the tablet terminal 20. The scanner 23 transmits the read merchandise code, the deadline information, and the clerk code to the control unit 200 of the tablet terminal 20. The scanner 23 may be a radio frequency identification (RFID) reading apparatus that reads an individual merchandise code that identifies individual merchandise or a merchandise code, and deadline information from a wireless tag attached to the merchandise.

The card reader 24 reads a member code from a medium such as a member card of the customer C or a point card thereof. The member code is an example of customer identification information that identifies the customer C. The card reader 24 may be a magnetic card reader that reads member information from a magnetic card, or an IC card reader that reads information from a card in which an IC chip is embedded.

The shopping cart 10 may be provided with a settlement terminal (not illustrated) for performing the cashless settlement such as the credit card settlement or the like. In this case, the settlement terminal forms the payment apparatus and is connected to a settlement server of a company performing the settlement via a network. The tablet terminal may be provided with a payment processing unit for communicating with the settlement server and performing the cashless settlement. In this case, the card reader 24 can be configured to read card information of a credit card and electronic money information of an electronic money card.

FIG. 3 is a block diagram illustrating a hardware configuration of the tablet terminal 20. The tablet terminal 20 includes the control unit 200, a memory unit 210, the display 21, the touch panel 22, the scanner 23, the card reader 24, a clock unit 220, and a communication unit 230. The control unit 200, the memory unit 210, the display 21, the touch panel 22, the scanner 23, the card reader 24, the clock unit 220, and the communication unit 230 are connected to each other via a bus 240 or the like.

The control unit 200 is formed of a computer including a central processing unit (CPU) 201, a read only memory (ROM) 202, and a random access memory (RAM) 203. The CPU 201, the ROM 202, and the RAM 203 are connected to each other via the bus 240.

The CPU 201 controls an overall operation of the tablet terminal 20. The ROM 202 stores various programs such as a program used to drive the CPU 201 and various data. The RAM 203 is used as a work area of the CPU 201, and loads various programs and various data stored in the ROM 202 and the memory unit 210. The control unit 200 executes various control processes of the tablet terminal 20 by operating the CPU 201 according to a control program that is stored in the ROM 202 or the memory unit 210, and then loaded in the RAM 203.

The RAM 203 includes a merchandise information storage unit 204 and a defective merchandise storage unit 205. The merchandise information storage unit 204 stores merchandise information of merchandise that is not defective merchandise, in other words, merchandise of which expiration date does not pass, among the pieces of merchandise of which merchandise code is read by the scanner 23. The merchandise is registered by storing the merchandise information in the merchandise information storage unit 204. FIG. 4 is a diagram illustrating a data configuration of the merchandise information storage unit 204. In the merchandise information storage unit 204, pieces of information indicating a merchandise code, a merchandise name, a price, and a quantity are stored in association with each other.

The merchandise code that identifies merchandise is registered in an item of the merchandise code. Information indicating the merchandise name is registered in an item of the merchandise name. Information indicating a unit price of merchandise is registered in an item of the price. The unit price of the merchandise may be a price of the merchandise itself or a price including consumption tax. Information indicating a quantity of merchandise registered as merchandise is registered in an item of the quantity.

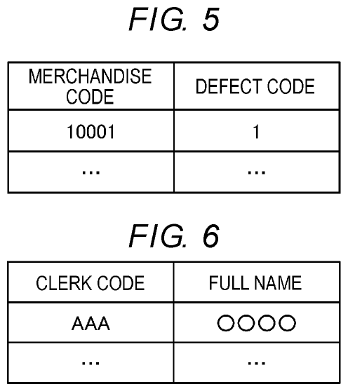

The defective merchandise storage unit 205 stores a merchandise code that identifies defective merchandise, in other words, merchandise of which expiration date passes, among the pieces of merchandise of which merchandise code is read by the scanner 23. FIG. 5 is a diagram illustrating a data configuration of the defective merchandise storage unit 205. In the defective merchandise storage unit 205, pieces of information indicating the merchandise code and a defect code are stored in association with each other.

The merchandise code that identifies merchandise is registered in an item of the merchandise code. Information indicating a defect of merchandise is registered in an item of the defect code. In the embodiment, “1” indicating that the expiration date passes is registered. If a store sets a plurality of pieces of defective merchandise, for example, if the store sets merchandise of which appearance is damaged as the defective merchandise in addition to the merchandise of which expiration date passes, “2” is registered as information indicating the merchandise of which appearance is damaged in the item of the defect code. If the store sets merchandise of which consumption expiration date passes as the defective merchandise instead of the merchandise of which expiration date passes, “3” is registered as information indicating the merchandise of which consumption expiration date passes in the item of the defect code. The defective merchandise is merchandise that is not intended to be sold by the store due to some defect, and includes, for example, the merchandise of which expiration date passes, the merchandise of which consumption expiration date passes, and the merchandise of which appearance is damaged. The defective merchandise can be freely and selectively set by the store depending on a situation.

The memory unit 210 is formed of a storage medium such as a hard disk drive (HDD) and a flash memory, and latches a stored content even when power is cut off. The memory unit 210 stores a control program 211, a merchandise master 212, and a clerk master 213.

The control program 211 is a program for causing the tablet terminal 20 to function as the merchandise registration apparatus in the payment system 1, and a program for determining whether or not merchandise is expired merchandise based on deadline information read, by the scanner 23, from a barcode attached to the merchandise.

The merchandise master 212 is a master file in which a merchandise code and merchandise information (a merchandise name, a price, or the like) are associated with merchandise available in a store. The merchandise master 212 is received from the server 3 via the communication unit 230. The merchandise master 212 is appropriately updated based on the information from the server 3.

The clerk master 213 is a master file in which information on a clerk is stored. FIG. 6 is a diagram illustrating a data configuration of the clerk master 213. Each data registered in the clerk master 213 is associated with a clerk code and a full name.

The clerk code that identifies the clerk is registered in an item of the clerk code. The clerk code is clerk identification information that identifies a clerk of a store that sells merchandise. If the clerk code is input, the control unit 200 can recognize that the tablet terminal 20 is operated by the clerk, in other words, the clerk is involved in an input operation such that the input is performed to the tablet terminal 20. Information indicating the full name of the clerk is registered in an item of the full name. In the embodiment, the clerk master 213 is stored in the memory unit 210 and the clerk code is used as the clerk identification information. The clerk identification information may not be information that identifies an individual clerk. For example, a file in which a store code and the full name are associated with each other may be stored in the memory unit 210, and the store code may be used as the clerk identification information.

Referring back to FIG. 3, the configuration and function of the display 21, the touch panel 22, the scanner 23, and the card reader 24 are described above. The clock unit 220 is a time tracking apparatus such as a real time clock (RTC) or the like, and tracks current time. The communication unit 230 is an interface for communicating with an external apparatus such as the payment apparatus 2, the server 3, or the like. The control unit 200 can transmit and receive information (data) to and from the external apparatus by being connected to the external apparatus via the communication unit 230.

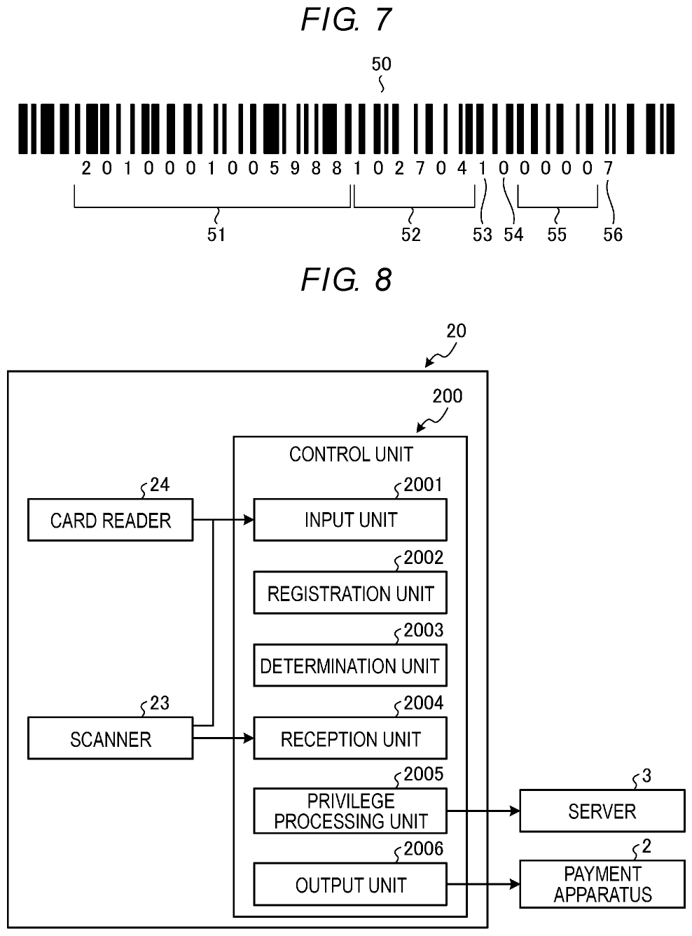

Next, an example of the barcode attached to the merchandise will be described. FIG. 7 is a diagram illustrating a content of data indicated by the barcode used in at least one embodiment. The barcode 50 is formed of a merchandise code section 51, a deadline information section 52, a date and time setting flag section 53, a discount processing flag section 54, a discount amount setting section 55, and a check digit section 56. In the following description, a discount that deducts a certain amount from a list price and a discount that deducts a certain percentage of the amount from the list price may be collectively referred to as a discount.

The merchandise code section 51 is data indicating a merchandise code that identifies merchandise, for example, a Japanese article number (JAN) code formed of 13 digits.

The deadline information section 52 is data formed of 6 digits indicating a deadline such as an expiration date or a consumption expiration date. As an example, an example of managing the deadline with the expiration date will be described. The deadline information section 52 is data in which first two digits indicate a month, next two digits indicate a day, and last two digits indicate time, and as an example, the example of FIG. 7 shows that the expiration date is 4:00 on October 27.

The date and time setting flag section 53 is data indicating whether comparison between the time when the scanner 23 reads information from the barcode 50 (hereinafter, also referred to as reading time) and the expiration date indicated by the deadline information section 52 is performed on a per date basis or on a per date-and-time basis. Specifically, if “0” is set in the date and time setting flag section 53, it is indicated that the date and time setting flag section 53 performs the comparison between the reading time and the expiration date indicated by the deadline information section 52 on a per date-and-time basis. If “1” is set in the date and time setting flag section 53, it is indicated that the date and time setting flag section 53 performs the comparison between the reading time and the expiration date indicated by the deadline information section 52 on a per date basis.

The discount processing flag section 54 is data indicating a discount method. The discount processing flag section 54 is used if the barcode 50 is used as a discount barcode attached to merchandise if the price is discounted from the list price. Specifically, if “1” is set in the discount processing flag section 54, the discount processing flag section 54 indicates that the discount is performed at a discount rate indicated by the discount amount setting section 55. If “2” is set in the discount processing flag section 54, the discount processing flag section 54 indicates that an amount indicated by the discount amount setting section 55 is discounted. If “3” is set in the discount processing flag section 54, the discount processing flag section 54 indicates that an amount indicated by the discount amount setting section 55 is used as a sales amount. If the barcode 50 is not the discount barcode, “0” is registered in the discount processing flag section 54 as illustrated in FIG. 7.

The discount amount setting section 55 is data indicating a discount rate, a discount amount, and a sales amount after the discount. The discount amount setting section 55 is used if the barcode 50 is used as the discount barcode in the same manner as that of the discount processing flag section 54. If the barcode 50 is not the discount barcode, “0000” is registered in the discount amount setting section 55 as illustrated in FIG. 7.

The check digit section 56 is data for checking whether the information read from the barcode by the scanner 23 is correct or not. A value calculated according to a predetermined rule is registered in the check digit section 56, based on numerical values registered in the merchandise code section 51, the deadline information section 52, the date and time setting flag section 53, the discount processing flag section 54, and the discount amount setting section 55.

Next, a functional configuration of the control unit 200 of the tablet terminal 20 will be described. FIG. 8 is a block diagram illustrating a main functional configuration of the control unit 200 of the tablet terminal 20. The control unit 200 functions as an input unit 2001, a registration unit 2002, a determination unit 2003, a reception unit 2004, a privilege processing unit 2005, and an output unit 2006 by operating the CPU 201 according to the control program stored in the ROM 202 or the memory unit 210. Each of these functions may be configured by hardware such as a dedicated circuit or the like.

Merchandise identification information that identifies merchandise and related information related to a state of the merchandise identified by the merchandise identification information are input to the input unit 2001. Specifically, the merchandise code read, by the scanner 23, from the barcode 50 attached to the merchandise and the deadline information indicating the expiration date are input to the input unit 2001. The deadline information input to the input unit 2001 may not be information indicating the deadline itself, but may be information indicating whether or not the deadline is exceeded. In this case, the scanner 23 compares the deadline indicated by the deadline information read from the barcode 50 with the reading time, and determines whether or not the reading time exceeds the deadline indicated by the deadline information. The member code read, by the card reader 24, from the member card owned by the customer C is input to the input unit 2001. Various information is input to the input unit 2001 from the touch panel 22. If the control unit 200 includes a decoding unit that decodes the barcode 50 recognized by the scanner 23, the merchandise code and the deadline information are input from the decoding unit to the input unit 2001.

The registration unit 2002 performs merchandise registration based on the merchandise identification information input to the input unit 2001. Specifically, the registration unit 2002 performs the merchandise registration on merchandise of which expiration date does not pass among the pieces of merchandise of which merchandise codes are read by the scanner 23. More specifically, the registration unit 2002 acquires, with respect to the merchandise of which expiration date does not pass, merchandise information (a merchandise name, a price, or the like) corresponding to the merchandise code input to the input unit 2001 from the merchandise master 212, and stores the merchandise code and the merchandise information in the merchandise information storage unit 204. The merchandise registration indicates that the merchandise information of the merchandise identified by the merchandise code input to the input unit 2001 is stored (registered) in the merchandise information storage unit 204. The registration unit 2002 stores, in the defective merchandise storage unit 205, a merchandise code of merchandise of which expiration date passes among the pieces of merchandise of which merchandise codes are read by the scanner 23.

The determination unit 2003 determines, based on the deadline information input to the input unit 2001, whether or not the merchandise identified by the merchandise identification information input to the input unit 2001 is expired defective merchandise. Specifically, the determination unit 2003 compares the deadline indicated by the deadline information input to the input unit 2001 with the reading time tracked by the clock unit 220, and determines whether or not the merchandise identified by the merchandise code input to the input unit 2001 is the expired defective merchandise. More specifically, if the reading time tracked by the clock unit 220 exceeds the deadline indicated by the deadline information input to the input unit 2001, the determination unit 2003 determines that the merchandise identified by the merchandise identification information input to the input unit 2001 is the expired defective merchandise. If the reading time tracked by the clock unit 220 does not exceed the deadline indicated by the deadline information input to the input unit 2001, the determination unit 2003 determines that the merchandise identified by the merchandise identification information input to the input unit 2001 is not defective merchandise. If “1” is set in the date and time setting flag section 53 of the barcode 50 attached to the merchandise, the determination unit 2003 compares a date of the reading time with a date indicated by the deadline information of the barcode 50, and determines whether or not the merchandise is the expired defective merchandise.

The reception unit 2004 receives instruction information indicating an instruction to execute a privilege process for giving privilege to the customer C. Specifically, the reception unit 2004 receives a clerk code read, by the scanner 23, from the barcode printed on the clerk's name plate. If the reception unit 2004 receives the clerk code after the merchandise identified by the merchandise code input to the input unit 2001 is determined, by the determination unit 2003, as the expired merchandise, the privilege processing unit 2005 executes the privilege process which will be described later. The clerk code received by the reception unit 2004 is an example of the instruction information. The reception unit 2004 may receive information indicating that the privilege is given to the customer C as the instruction information, instead of the clerk code. For example, the reception unit 2004 may receive a privilege code (the instruction information) indicating the privilege to be given via the scanner 23, instead of the clerk code. The reception unit 2004 may receive the clerk code or privilege code input to the touch panel 22.

If the merchandise identified by the merchandise identification information input to the input unit 2001 is determined as the defective merchandise based on the related information, and the reception unit 2004 receives the instruction information, the privilege processing unit 2005 executes the privilege process for giving the privilege to the customer C. Specifically, if the merchandise identified by the merchandise code input to the input unit 2001 is determined as the expired merchandise, the privilege processing unit 2005 executes a process for giving a point to the customer C who intends to purchase the expired merchandise. For example, the privilege processing unit 2005 outputs, to the server 3, point information including a predetermined point and a member code of the customer C who is given the point. For example, if the merchandise of which merchandise code is input to the input unit 2001 is the defective merchandise, and the reception unit 2004 receives the instruction information, the privilege processing unit 2005 outputs, to the server 3, the point information including request information for requesting a point to be given and the member code of the customer C, and the server 3 receiving the request information may give the predetermined point. In the following description, the point given to the customer C who intends to purchase the expired merchandise may be referred to as a “point for the expired merchandise”. The store can give the point for the expired merchandise to the customer C by updating the point management file 32 by the server 3. The point for the expired merchandise may be a predetermined fixed point, or may be a point corresponding to a price of the expired merchandise or a point corresponding to a point currently held by the customer C, or can be freely and selectively set by the store.

The privilege given to the customer C by the store is not limited to the point to be given, and may be provision of a small gift, provision of a discount coupon, or the like. If the privilege is provided as the small gift or the discount coupon, the privilege processing unit 2005 stores, for example, privilege information received by the reception unit 2004, and then reads and displays the privilege information on the display 21. Accordingly, the customer C can display the privilege information on the display 21 at a service counter of the store and receive the small gift or the discount coupon.

The output unit 2006 outputs, to the payment apparatus 2, payment information for paying a price of the merchandise registered as merchandise in the registration unit 2002. For example, the output unit 2006 outputs, to the payment apparatus 2, the merchandise code, the merchandise name, the price, or the like of the merchandise registered as merchandise by the registration unit 2002 as the payment information. The output unit 2006 also outputs the member code input to the input unit 2001 to the payment apparatus 2.

If the point for the expired merchandise is not given to customer C at the time of outputting the payment information, the output unit 2006 outputs information indicating the point for the expired merchandise to the payment apparatus 2 together with the payment information and the member code. It is assumed that the customer C does not notice the expired merchandise, or the customer C notices the expired merchandise but cannot find a clerk in a sales floor, and then reaches the payment apparatus 2 in a state where the clerk code which is the instruction information is not input. At this time, in addition to the payment code and the payment information, the output unit 2006 outputs, to the payment apparatus 2, information stored in the defective merchandise storage unit 205 as the information indicating the point for the expired merchandise. Next, the payment apparatus 2 outputs, to the server 3, the point information including the request information for requesting the point to be given and the member code of the customer C. Accordingly, if the point for the expired merchandise cannot be given to the customer C by the process of the privilege processing unit 2005, the point for the expired merchandise can be given to the customer C by the process of the payment apparatus 2.

When receiving the payment information and the member code from the output unit 2006, the payment apparatus 2 executes a payment process. The payment process executed by the payment apparatus 2 is a process for paying a price of merchandise purchased by the customer C, such as calculation and display of a total amount, calculation and display of a coin, dispensing of a receipt, or the like. The payment process in the embodiment also includes a process of outputting a point to be given according to the paid amount to the server 3. If the payment apparatus 2 receives the information indicating the point for the expired merchandise from the output unit 2006, for example, the payment apparatus 2 turns on a display lamp and calls a clerk. The clerk operates the payment apparatus 2 to give the point for the expired merchandise to the customer C, and collects the expired merchandise from the customer C.

If the shopping cart 10 includes the settlement terminal for performing the cashless settlement such as the credit card settlement or the like as described above, the output unit 2006 outputs the payment information to the settlement terminal. As described above, if the tablet terminal 20 includes the payment processing unit for communicating with the settlement server and performing the cashless settlement, the output unit 2006 outputs the payment information to the payment processing unit.

An outline of an operation of the payment system 1 having the above-described configuration will be described. First, the customer C inputs the member code to the tablet terminal 20. The member code may be input by causing the card reader 24 to read the member card, or by inputting the member code to the touch panel 22. By inputting the member code to the tablet terminal 20, the customer C can use the tablet terminal as the merchandise registration apparatus and do the shopping. The customer C pushes the shopping cart 10 to move in a sales floor, reads, by the scanner 23, the merchandise code indicated by the barcode 50 attached to the merchandise to be purchased, and stores the merchandise in the basket K. The customer C performs the same operation on all the pieces of merchandise to be purchased.

If the merchandise identified by the merchandise code read by the scanner 23 is the expired merchandise that exceeds the deadline (for example, the expiration date), the tablet terminal 20 stores the merchandise code or the like in the defective merchandise storage unit 205. The tablet terminal 20 displays information on the display 21. The information to be displayed includes, for example, a message notifying that the merchandise that the customer C intends to purchase is the expired merchandise, an apology message for displaying the expired merchandise that cannot be sold, a message notifying that a point can be obtained by notifying a clerk of existence of the expired merchandise, or the like.

The customer C who confirms the information displayed on the display 21 hands the expired merchandise over to the clerk in the store. The clerk collects the expired merchandise and inputs the clerk code to the tablet terminal 20.

When receiving the clerk code, the tablet terminal 20 outputs, to the server 3, information for giving the point for the expired merchandise to the customer C on the condition that the merchandise code is registered in the defective merchandise storage unit 205. The server 3 updates the point management file 32 based on the received information, and gives the point for the expired merchandise to the customer C.

Accordingly, if the customer C intends to purchase the expired merchandise that the store cannot completely exclude from a merchandise display shelf, the clerk can collect the expired merchandise, and discomfort felt by the customer C can be prevented by giving the point to the customer C. Particularly, the payment system 1 is effective for a store that sells merchandise which is close to an expiration date at a discount. This is because it is not easy to exclude all the pieces of expired merchandise from the merchandise display shelves if the expiration date passes.

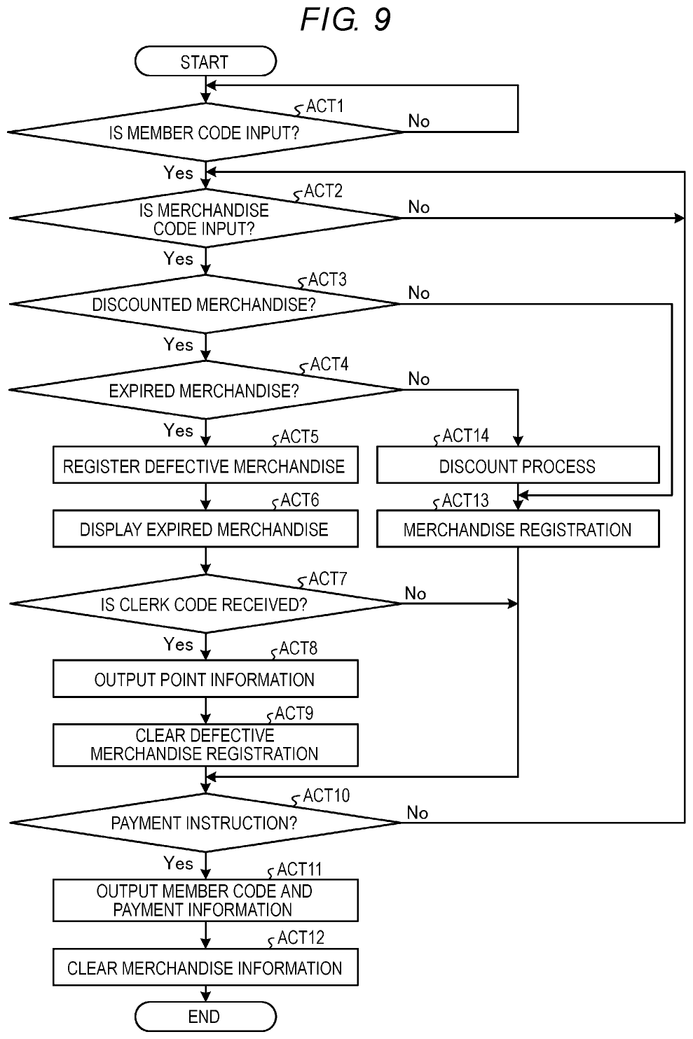

Next, a process of the control unit 200 of the tablet terminal 20 will be described. FIG. 9 is a flowchart illustrating a process flow by the control unit 200 of the tablet terminal 20.

First, the control unit 200 determines whether or not a member code is input to the input unit 2001 (ACT 1), and if the member code is not input thereto (N in ACT 1), the control unit 200 returns to the process of ACT 1 and waits. If the member code is input thereto (Y in ACT 1), the control unit 200 determines whether or not a merchandise code is input to the input unit 2001 (ACT 2), and if the merchandise code is not input thereto (N in ACT 2), the control unit 200 returns to the process of ACT 2 and waits. In other words, the control unit 200 determines whether or not the scanner 23 reads the merchandise code from the barcode 50 attached to merchandise.

If the merchandise code is input to the input unit 2001 (Y in ACT 2), the control unit 200 determines whether or not the merchandise identified by the input merchandise code is discounted merchandise (ACT 3). In other words, the control unit 200 determines whether or not the barcode 50, from which the merchandise code is read by the scanner 23, is a discount barcode. The control unit 200 determines whether or not the merchandise is the discounted merchandise based on a value of the discount processing flag section 54 of the barcode 50. Specifically, the control unit 200 determines the merchandise is the discounted merchandise if any one of “1”, “2”, and “3” is set in the discount processing flag section 54. On the other hand, the control unit 200 determines that the merchandise is not the discounted merchandise if “0” is set therein.

If the merchandise is the discounted merchandise (Y in ACT 3), the determination unit 2003 determines whether or not the merchandise identified by the merchandise code input to the input unit 2001 is expired merchandise of which expiration date passes (ACT 4). The determination unit 2003 determines whether or not the merchandise is the expired merchandise, based on current time tracked by the clock unit 220 and an expiration date indicated by a value set in the deadline information section 52 of the barcode 50. The determination unit 2003 can also determine whether or not merchandise, which is not the discounted merchandise, is the expired merchandise (the determination unit 2003 may determine whether the merchandise is defective merchandise regardless of whether the merchandise is the discounted merchandise or not).

If the merchandise is determined as the expired merchandise (Y in ACT 4), the registration unit 2002 registers the expired merchandise as the defective merchandise (ACT 5). Specifically, the registration unit 2002 stores the merchandise code of the expired merchandise and a defect code in association with each other in the defective merchandise storage unit 205 (ACT 5). Next, the control unit 200 displays, on the display 21, that the merchandise identified by the merchandise code read by the scanner 23 is the expired merchandise (ACT 6). At the same time, the control unit 200 displays, on the display 21, an apology message for displaying the expired merchandise that cannot be sold, a message notifying that a point can be obtained by notifying a clerk of existence of the expired merchandise, or the like.

Next, the control unit 200 determines whether or not the reception unit 2004 receives a clerk code (ACT 7). In other words, the control unit 200 determines whether or not the reception unit 2004 receives instruction information indicating an instruction to execute a privilege process.

If the clerk code is received (Y in ACT 7), the privilege processing unit 2005 outputs point information to the server 3 (ACT 8). The point information output by the privilege processing unit 2005 is, for example, information including a member code and a point to be given to the customer C identified by the member code. Next, the registration unit 2002 clears the defective merchandise registration performed in the process of ACT 5 (ACT 9).

After the process of ACT 9, the control unit 200 determines whether or not a payment instruction is input to the input unit 2001 (ACT 10), and if the payment instruction is not input thereto (N in ACT 10), the control unit 200 returns to the process of ACT 2. If the payment instruction is input thereto (Y in ACT 10), the output unit 2006 outputs the member code and payment information to the payment apparatus 2 (ACT 11). Next, the registration unit 2002 clears merchandise information stored in the merchandise information storage unit 204 (ACT 12). Next, the control unit 200 finishes the process.

In the process of ACT 3, if the merchandise identified by the merchandise code input to the input unit 2001 is not the discounted merchandise (N in ACT 3), the registration unit 2002 performs merchandise registration based on the merchandise code (ACT 13). That is, the registration unit 2002 acquires the merchandise information (a merchandise name, a price, or the like) corresponding to the merchandise code input to the input unit 2001 from the merchandise master 212, and stores the pieces of merchandise information in association with the merchandise code in the merchandise information storage unit 204. Next, the control unit 200 proceeds to the process of ACT 10.

In the process of ACT 4, if the merchandise identified by the merchandise code input to the input unit 2001 is not the expired merchandise (N in ACT 4), the control unit 200 performs a discount process (ACT 14) and proceeds to the process of ACT 13. The discount process is a process of calculating a price of the merchandise based on data of the discount processing flag section 54 and the discount amount setting section 55 of the barcode 50. The price calculated by the discount process is a part of the merchandise information.

If the clerk code is not received in the process of ACT 7 (N in ACT 7), the control unit 200 skips the processes of ACT 8 and ACT 9 and proceeds to the process of ACT 10. In this case, in ACT 11, in addition to the payment code and the payment information, information stored in the defective merchandise storage unit 205 is also output to the payment apparatus 2. Accordingly, if the customer C does not notice the expired merchandise, or if the customer C cannot find a clerk in a sales floor, the payment apparatus 2 can give a point for the expired merchandise. For example, the payment apparatus 2 calls the clerk by turning on a display lamp or by giving a notification to an attendant apparatus (not illustrated) that monitors the payment apparatus 2, such that the customer C can be given the point for the expired merchandise by an operation of the clerk.

In the embodiment, the tablet terminal 20 reads deadline information for determining whether or not the expiration date passes from the barcode attached to the merchandise. The tablet terminal 20 may acquire the deadline information from the server 3. In other words, the deadline information may be managed by the server 3. For example, the server 3 stores information in which the merchandise information (the merchandise name, the price, or the like) and the deadline information are associated with an identification code that can identify individual merchandise. Alternatively, the server 3 stores information in which the merchandise code and the deadline information are associated with the identification code. Next, the tablet terminal 20 may acquire the deadline information corresponding to the identification code read by the scanner 23 or the like from the server 3, and may determine whether or not the merchandise identified by the identification code is the expired merchandise.

According to at least one embodiment, if the store cannot completely exclude merchandise of which expiration date passes and the customer C intends to purchase the merchandise of which expiration date passes, the clerk operates the tablet terminal 20 to give the point to the customer C. Accordingly, the customer C who intends to purchase the expired merchandise can obtain the privilege, and the customer C can be prevented from feeling embarrassed. Since the expired merchandise can be collected if the clerk operates the tablet terminal 20, the store can prevent the expired merchandise from being taken out of the store.

When receiving the clerk code (the instruction information), the tablet terminal 20 executes the privilege process on the condition that the merchandise code is registered in the defective merchandise storage unit 205. That is, the tablet terminal 20 does not simply execute the privilege process when receiving the clerk code, but executes the privilege process on the condition that the barcode attached to the defective merchandise is read in order to purchase the defective merchandise. Accordingly, it is possible to prevent the point from being given in error. For example, even though the clerk code is input to the tablet terminal 20 by the customer C who erroneously obtains the clerk code (the instruction information), the customer C is not given the privilege by itself, such that the point can be prevented from being given in error.

### Second Embodiment

Next, a second exemplary embodiment will be described. The second embodiment is different from the first embodiment in that merchandise recognized to have a damaged appearance (hereinafter, also referred to as “damaged merchandise”) is regarded as the defective merchandise. The damaged merchandise is, for example, merchandise of which package is torn, merchandise of which package is broken or dented, or the like. The merchandise registration apparatus did not perform the merchandise registration on the defective merchandise in the first embodiment. On the other hand, the merchandise registration apparatus in the second embodiment performs the merchandise registration if the customer C recognizes damage to the appearance of merchandise and then purchases the damaged merchandise. Hereinafter, description of the same configuration as that of the first embodiment may be omitted. This is to avoid unnecessary redundancy in the following description and to allow those skilled in the art to easily understand the embodiment.

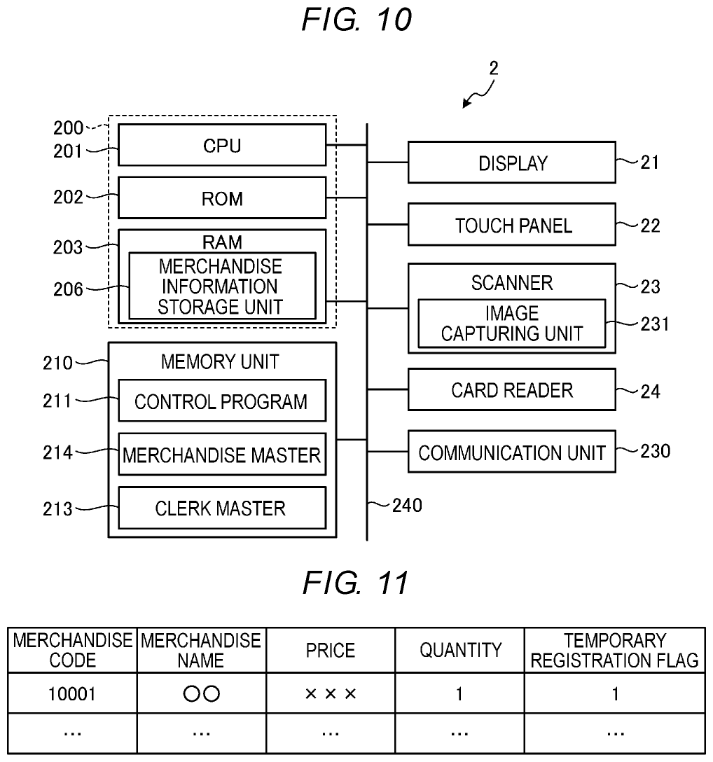

FIG. 10 is a block diagram illustrating a hardware configuration of the merchandise registration apparatus according to the second embodiment. The RAM 203 includes a merchandise information storage unit 206. The merchandise information storage unit 206 stores merchandise information or the like of merchandise of which merchandise code is read by the scanner 23. FIG. 11 is a diagram illustrating a data configuration of the merchandise information storage unit 206. In the merchandise information storage unit 206, pieces of information indicating a merchandise code, a merchandise name, a price, a quantity, and a temporary registration flag are stored in association with each other.

Each information registered in items of the merchandise code, the merchandise name, the price, and the quantity is the same as that of the first embodiment. The temporary registration flag is information indicating whether or not the corresponding merchandise information is in a temporary registration state. Merchandise information in which “1” is registered in the temporary registration flag is in the temporary registration state, and it is considered that the merchandise registration is not performed, such that the merchandise information is not included in payment information. For example, if it is recognized that an appearance of merchandise of which merchandise code is read by the scanner 23 is damaged, the merchandise information of the merchandise is registered in the merchandise information storage unit 206 in a state where the temporary registration flag is set to “1”. After that, if the customer C performs an input to purchase the merchandise, the temporary registration flag is rewritten to “0” and the merchandise registration is performed.

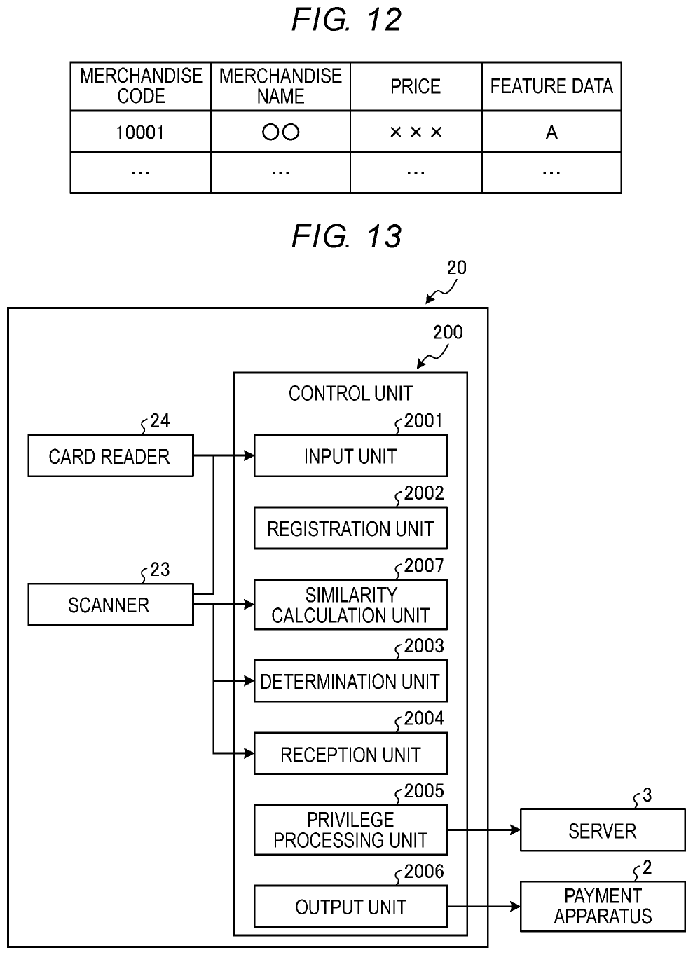

A merchandise master 214 is stored in the memory unit 210. The merchandise master 214 is a master file in which a merchandise code and merchandise information are associated with the merchandise available in a store. FIG. 12 is a diagram illustrating a data configuration of the merchandise master 214. In the merchandise master 214, pieces of information indicating a merchandise code, a merchandise name, a price, and feature data are stored in association with each other.

Each information registered in items of the merchandise code, the merchandise name, and the price is the same as the information registered in the merchandise information storage unit 206. The information registered in an item of the feature data is collation information indicating feature data of a merchandise appearance.

Referring back to FIG. 10, the scanner 23 includes an image capturing unit 231. The scanner 23 extracts an image of the barcode 50 attached to the merchandise from an image captured by the image capturing unit 231, decodes the extracted barcode 50, and reads the merchandise code or the like indicated by the barcode 50. The scanner 23 extracts feature data of the merchandise from the image captured by the image capturing unit 231 and outputs information indicating the feature data thereof to the control unit 200. The information indicating the feature data of the merchandise output by the scanner 23 is an example of related information related to a state of the merchandise. The feature data of the merchandise may be extracted by the control unit 200. In this case, the scanner 23 outputs information on the captured image to the control unit 200, and the information on the captured image output by the scanner 23 becomes the related information. The control unit 200 determines whether or not the merchandise is damaged merchandise by comparing the feature data of the merchandise image captured by the image capturing unit 231 with the feature data registered in the merchandise master 214. Extracting the feature data of the merchandise image captured by the image capturing unit 231 is implemented by using a well-known image recognition technique such as generic object recognition or the like.

Next, a functional configuration of the control unit 200 of the tablet terminal 20 will be described. FIG. 13 is a block diagram illustrating a main functional configuration of the control unit 200 of the tablet terminal 20. The control unit 200 functions as the input unit 2001, the registration unit 2002, the determination unit 2003, the reception unit 2004, the privilege processing unit 2005, the output unit 2006, and a similarity calculation unit 2007 by operating the CPU 201 according to the control program stored in the ROM 202 or the memory unit 210. Each of these functions may be configured by hardware such as a dedicated circuit or the like.

The functions of the input unit 2001, the registration unit 2002, the determination unit 2003, the reception unit 2004, the privilege processing unit 2005, and the output unit 2006 are the same as those of the first embodiment.

The similarity calculation unit 2007 compares the collation feature data of the merchandise registered in the merchandise master 214 with the feature data of the merchandise extracted by the scanner 23, thereby calculating similarity between an appearance of merchandise captured by the image capturing unit 231 and an original appearance of the merchandise.

If the similarity calculated by the similarity calculation unit 2007 is equal to or less than a predetermined setting value, the determination unit 2003 determines that the merchandise identified by the merchandise code input to the input unit 2001 is the damaged merchandise. The setting value can be freely and selectively set for each merchandise.

In the second embodiment, the tablet terminal 20 displays information on the display 21 if the merchandise identified by the merchandise code read by the scanner 23 is the damaged merchandise of which appearance is damaged. The information to be displayed thereon includes, for example, a message notifying that the merchandise that customer C intends to purchase is the damaged merchandise, a message requesting the customer C to input whether or not to purchase the merchandise, a button for selecting whether or not to purchase the merchandise, a message notifying that a point can be obtained by notifying a clerk of existence of the damaged merchandise, or the like.

In the same manner as that of the first embodiment, the customer C can obtain the point by allowing the clerk to input the clerk code to the tablet terminal 20. Accordingly, it is possible to prevent discomfort felt by the customer C who intends to purchase the damaged merchandise. The tablet terminal 20 may give the point to the customer C on the condition that the customer C purchases the damaged merchandise.

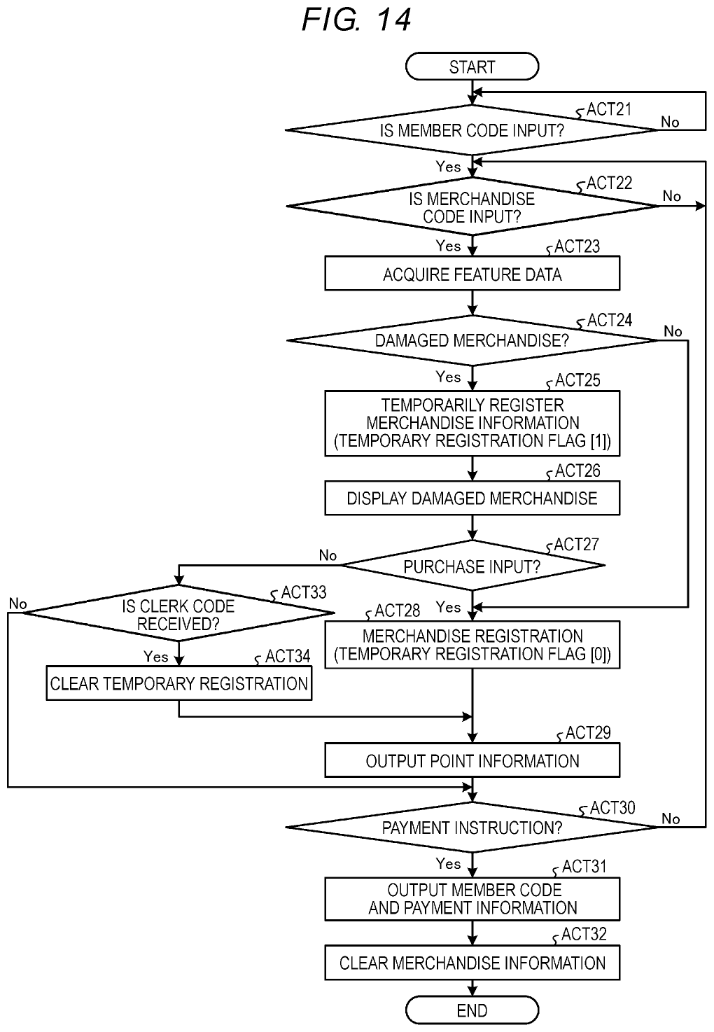

Next, a process of the control unit 200 of the tablet terminal 20 will be described. FIG. 14 is a flowchart illustrating a process flow by the control unit 200 of the tablet terminal 20.

First, the control unit 200 determines whether or not a member code is input to the input unit 2001 (ACT 21), and if the member code is not input thereto (N in ACT 21), the control unit 200 returns to the process of ACT 21 and waits. If the member code is input thereto (Y in ACT 21), the control unit 200 determines whether or not a merchandise code is input to the input unit 2001 (ACT 22), and if the merchandise code is not input thereto (N in ACT 22), the control unit 200 returns to the process of ACT 22 and waits. In other words, the control unit 200 determines whether or not the scanner 23 reads the merchandise code from the barcode attached to merchandise.

If the merchandise code is input to the input unit 2001 (Y in ACT 22), the similarity calculation unit 2007 acquires feature data of a merchandise image captured by the image capturing unit 231 from the scanner 23 (ACT 23). The determination unit 2003 determines whether or not the merchandise identified by the merchandise code input to the input unit 2001, that is, the merchandise captured by the image capturing unit 231 is damaged merchandise (ACT 24). The determination unit 2003 determines whether or not the merchandise is the damaged merchandise based on similarity calculated by the similarity calculation unit 2007.

If the merchandise is the damaged merchandise (Y in ACT 24), the registration unit 2002 temporarily registers merchandise information of the damaged merchandise (ACT 25). Specifically, the registration unit 2002 registers the merchandise information in which the temporary registration flag is set to “1” in the merchandise information storage unit 206. At this time, in the same manner as that of the first embodiment, a defective merchandise storage unit may be provided in the RAM 203, and the merchandise code input to the input unit 2001 may be associated with a defect code and stored in the defective merchandise storage unit. In this case, “2” is registered in an item of the defect code as information indicating that the merchandise is the merchandise of which appearance is damaged.

Next, the control unit 200 displays, on the display 21, that the merchandise identified by the merchandise code read by the scanner 23 is the damaged merchandise (ACT 26). At the same time, the control unit 200 displays, on the display 21, a message requesting the customer C to input whether or not to purchase the merchandise, a button for selecting whether or not to purchase the merchandise, a message notifying that a point can be obtained by notifying a clerk of existence of the damaged merchandise, or the like.

Next, the control unit 200 determines whether or not the customer C performs an input to purchase the damaged merchandise and the reception unit 2004 receives information indicating the purchase of the damaged merchandise (ACT 27). The control unit 200 performs the determination based on an input to the button for selecting whether or not to purchase the damaged merchandise displayed in the process of ACT 26.

If the information indicating the purchase of the damaged merchandise is received (Y in ACT 27), the registration unit 2002 finalizes the registration of the merchandise information temporarily registered in the merchandise information storage unit 206 (ACT 28). Specifically, the registration unit 2002 rewrites the temporary registration flag of the merchandise information storage unit 206 from “1” to “0” for the merchandise that the customer C intends to purchase. The information indicating the purchase of the damaged merchandise is an example of instruction information indicating an instruction to execute a privilege process for giving privilege to the customer C.

Next, the privilege processing unit 2005 outputs point information to the server 3 (ACT 29). The point information output by the privilege processing unit 2005 is information including a member code and a point given to the customer C identified by the member code. The control unit 200 determines whether or not a payment instruction is input to the input unit 2001 (ACT 30), and if the payment instruction is not input thereto (N in ACT 30), the control unit 200 returns to the process of ACT 22.

If the payment instruction is input thereto (Y in ACT 30), the output unit 2006 outputs the member code and payment information to the payment apparatus 2 (ACT 31). Next, the registration unit 2002 clears the merchandise information stored in the merchandise information storage unit 206 (ACT 32). Next, the control unit 200 finishes the process.

In the process of ACT 24, if the merchandise identified by the merchandise code input to the input unit 2001 is not the damaged merchandise (N in ACT 24), the control unit 200 proceeds to the process of ACT 28 and performs the merchandise registration.

If the purchase input is not performed in the process of ACT 27 (N in ACT 27), the control unit 200 determines whether or not the reception unit 2004 receives the clerk code (ACT 33), and if the reception unit 2004 does not receive the clerk code (N in ACT 33), the control unit 200 proceeds to the process of ACT 30. In this case, in ACT 31, in addition to the payment code and the payment information, information indicating a point for the defective merchandise is also output to the payment apparatus 2. As the information indicating the point for the defective merchandise, for example, it is possible to use information in which the merchandise code and a value of the temporary registration flag are associated with each other, with respect to the merchandise of which value of the temporary registration flag is “1” in the merchandise information storage unit 206. If the defective merchandise storage unit is provided in the same manner as that of the first embodiment, as the information indicating the point for the defective merchandise, the information stored in the defective information storage unit can be used. If the reception unit 2004 receives the clerk code (Y in ACT 33), the registration unit 2002 clears the merchandise information temporarily registered in the merchandise information storage unit 206 (ACT 34). After that, the control unit 200 proceeds to the process of ACT 29.

According to the second embodiment, if the customer C intends to purchase the damaged merchandise, the point is given to the customer C. Accordingly, the customer C who intends to purchase the damaged merchandise can obtain the privilege, such that discomfort felt by the customer C can be prevented.

As described above, the merchandise registration apparatus of the embodiment includes: the input unit 2001 to which the merchandise identification information for identifying merchandise and the related information related to the state of the merchandise identified by the merchandise identification information are input; the registration unit 2002 that performs the merchandise registration based on the merchandise identification information input to the input unit 2001; the reception unit 2004 that receives the instruction information indicating an instruction to execute the privilege process for giving the privilege to the customer C; and the privilege processing unit 2005 that executes the privilege process if the merchandise identified by the merchandise identification information input to the input unit 2001 is determined as the defective merchandise based on the related information, and the reception unit 2004 receives the information on giving the privilege to the customer C.

Accordingly, if defective merchandise such as expired merchandise, damaged merchandise, or the like that a store does not intend to sell is displayed, and the customer C intends to purchase the defective merchandise, the customer C can be given the privilege. Therefore, the store that adopts the merchandise registration apparatus of the embodiment can prevent the customer C who intends to purchase the defective merchandise from feeling discomfort with respect to the store.

The merchandise registration apparatus of the embodiment is a merchandise registration apparatus that performs the merchandise registration by the operation of customer C. The instruction information is the clerk identification information indicating that the clerk is a clerk of the store that sells the merchandise.

Accordingly, the merchandise registration apparatus operated by the customer executes the privilege process by allowing the clerk to be involved in the process. Therefore, it is possible for the clerk to collect the defective merchandise such as the expired merchandise or the like. In other words, the merchandise registration apparatus operated by the customer executes the privilege process by allowing the clerk to be involved in the process, such that the clerk can be given an opportunity to collect the defective merchandise. Therefore, the store can prevent the discomfort felt by the customer C, and can reliably collect the defective merchandise required to be collected.

If the merchandise registration apparatus is operated by the customer C who moves in the store as described in the embodiment, it is possible to give the privilege to the customer C who does the shopping while moving in the store before the payment. Therefore, since it is possible to quickly respond to the customer C who intends to purchase the defective merchandise, the discomfort felt by the customer C can be further prevented.

The merchandise registration apparatus of the embodiment further includes the determination unit 2003 that determines whether or not the merchandise identified by the merchandise identification information input to the input unit 2001 is the expired defective merchandise, based on the related information which is information on the deadline of the merchandise.

Accordingly, for example, it is possible to prevent the discomfort or dissatisfaction felt by the customer C who intends to purchase the defective merchandise of which the expiration date and consumption expiration date have passed. The merchandise registration apparatus is particularly effective if the merchandise is sold at a discount near the deadline. The reason is that it is not easy for the store to remove all the pieces of expired merchandise from the sales floor immediately after the deadline, such that the customer Chas many opportunities of purchasing the expired merchandise.

The merchandise registration apparatus of the embodiment further includes the determination unit 2003 that determines whether or not the merchandise identified by the merchandise identification information input to the input unit 2001 is the defective merchandise having a recognizably damaged appearance, based on the related information which is information related to the appearance of the merchandise.

Accordingly, it is possible to prevent the discomfort or dissatisfaction felt by the customer C who intends to purchase the defective merchandise having a visibly damaged appearance.

In the merchandise registration apparatus of the embodiment, the privilege processing unit 2005 outputs, to a server that manages the point that can be used to purchase the merchandise for each customer, the customer identification information that identifies the customer C and the point information indicating the point to be given to the customer C identified by the customer identification information.

Accordingly, the store can give the point as a privilege to the customer C. As the privilege given to the customer C by the store, a small gift or the like may be provided, and since the point can be given only by operating the merchandise registration apparatus, the store can easily give the privilege to the customer C.

In at least one embodiment, the control program executed by the tablet terminal 20 which is a merchandise registration apparatus may be configured to be recorded and provided on a computer-readable recording medium such as a CD-ROM or the like. The control program executed by the tablet terminal 20 of the embodiment may be configured to be provided by being stored in a computer connected to a network such as the Internet or the like, and downloaded via the network, and may be configured to be provided via the network such as the Internet.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, a merchandise registration apparatus that moves in a store may include a unit for specifying its own location, such that when determining that merchandise of which merchandise code is read is defective merchandise, the merchandise registration apparatus may be able to output information indicating its own location to an apparatus that can be recognized by a clerk. For example, the merchandise registration apparatus can specify its own location by including a global positioning system (GPS) receiver and a receiver that receives a reference signal output from a plurality of beacon transmitters provided in the store. The merchandise registration apparatus can output the information indicating its own location to the server 3 connected to a display in the store or a terminal apparatus carried by the clerk. Accordingly, the clerk can recognize the location of the merchandise registration apparatus that determines the defective merchandise, and can promptly respond to the customer C who intends to purchase the defective merchandise.

What is claimed is:

1. A merchandise registration apparatus comprising a processor configured to:
receive as an input merchandise identification information that identifies merchandise and related information relating to a state of the merchandise identified by the merchandise identification information;
perform merchandise registration based on the merchandise identification information;
receive instruction information indicating an instruction to execute a privilege process for providing a privilege to a customer; and
execute the privilege process in response to determining, based on the related information, the merchandise identified by the merchandise identification information as defective merchandise, and receiving the instruction information.

2. The merchandise registration apparatus according to claim 1, wherein
the merchandise registration apparatus is configured to perform the merchandise registration based on the merchandise identification information input by the customer, and
the instruction information is clerk identification information indicating a clerk at a store offering the merchandise.

3. The merchandise registration apparatus according to claim 1, wherein
the related information is deadline information indicating an expiration date of the merchandise, and
the processor being further configured to determine, based on the related information, whether the merchandise identified by the merchandise identification information is expired defective merchandise.

4. The merchandise registration apparatus according to claim 1, wherein
the related information is information related to an appearance of the merchandise, and
the processor being further configured to determine, based on the related information, whether the merchandise identified by the merchandise identification information is defective merchandise having a damaged appearance.

5. The merchandise registration apparatus according to claim 1, wherein
the processor is configured to output to a server configured to manage point information, customer identification information that identifies the customer and request information that indicates a point used for purchasing the merchandise is to be given to the customer.

6. A method for controlling a merchandise registration apparatus having a processor to register merchandise purchased by a customer, the method comprising:
inputting merchandise identification information to identify merchandise and related information related to a state of the merchandise identified by the merchandise identification information;
performing merchandise registration based on the merchandise identification information;
receiving instruction information indicating an instruction to execute a privilege process for giving a privilege to the customer; and
executing the privilege process in response to determining, based on the related information, the merchandise identified by the merchandise identification information is defective merchandise, and receiving the instruction information.

7. The method according to claim 6, further comprising determining, based on the related information, whether the merchandise identified by the merchandise identification information is expired defective merchandise,
wherein the related information is deadline information indicating an expiration date of the merchandise.

8. The method according to claim 6, further comprising determining, based on the related information, whether the merchandise identified by the merchandise identification information is defective merchandise having a damaged appearance,
wherein the related information is information related to an appearance of the merchandise.

9. The method according to claim 6, further comprising outputting, to a server configured to manage point information, customer identification information that identifies the customer and request information that indicates a point used for purchasing the merchandise is to be given to the customer.

10. A non-transitory computer-readable medium comprising instructions, which, when executed by a processor, cause a merchandise registration apparatus to perform operations to register merchandise purchased by a customer, the operations comprising:
inputting merchandise identification information to identify merchandise and related information related to a state of the merchandise identified by the merchandise identification information;
performing merchandise registration based on the merchandise identification information;
receiving instruction information indicating an instruction to execute a privilege process for giving a privilege to the customer; and
executing the privilege process in response to determining, based on the related information, the merchandise identified by the merchandise identification information is defective merchandise, and receiving the instruction information.

11. The non-transitory computer-readable medium according to claim 10, wherein the operations further comprise determining, based on the related information, whether the merchandise identified by the merchandise identification information is expired defective merchandise, and
wherein the related information is deadline information indicating an expiration date of the merchandise.

12. The non-transitory computer readable medium according to claim 10, wherein the operations further comprise determining, based on the related information, whether the merchandise identified by the merchandise identification information is defective merchandise having a damaged appearance, and
wherein the related information is information related to an appearance of the merchandise.

13. The non-transitory computer readable medium according to claim 10, wherein the operations further comprise outputting, to a server configured to manage point information, customer identification information that identifies the customer and request information that indicates a point used for purchasing the merchandise is to be given to the customer.
